(19) United States
(12) Patent Application Publication
(10) Pub. No.: US 2025/0376602 A1
(43) Pub. Date: Dec. 11, 2025

(54) A POLYOL COMPOSITION FOR THE PRODUCTION OF POLYURETHANE FOAMS SUITABLE FOR FILLING HOLLOW CORE INSULATORS

(71) Applicant: HUNTSMAN ADVANCED MATERIALS (SWITZERLAND) GMBH, Basel (CH)

(72) Inventors: Christian BEISELE, Basel (CH); Daniel BAER, Basel (CH); Hubert WILBERS, Basel (CH)

(21) Appl. No.: 18/875,757

(22) PCT Filed: May 5, 2023
(86) PCT No.: PCT/EP2023/062033

§ 371 Date: Dec. 17, 2024

(30) Foreign Application Priority Data
Jun. 27, 2022 (EP) 22181198.7

(51) Int. Cl. C09D 175/08; C09D 7/61; C09D 7/65; H01B 3/30

(52) U.S. Cl. CPC C09D 175/08; C09D 7/61; C09D 7/65; H01B 3/302

(57) ABSTRACT

The invention relates to a polyol composition comprising, based on the total weight of the composition
a1) from 35% to 90% by weight of one or more polyether polyols having an average hydroxyl functionality of greater than 2,
a2) from 10% to 50% by weight of castor oil,
a3) from 5% to 30% by weight of one or more mineral oil,
a4) from 0.05% to 10% by weight of one or more foam stabilizing agent, wherein at least 80% by weight of the total weight of polyols in the composition is provided by the polyether polyol a1) and the castor oil a2).

The invention also relates to a two-constituent composition for the production of polyurethane foams comprising the polyol composition and a polyisocyanate compound. The invention further relates to the use of the polyurethane foams prepared from this composition for filling hollow core insulators, as well as to the hollow core insulator filled with the polyurethane foam.

The present invention is directed to a polyol composition which in combination with a polyisocyanate provide polyurethane foams. The invention also relates to the use of the polyurethane foams for filling hollow core insulators.

### STATE OF THE ART

Hollow core insulators have an important position in the various fields of application for high voltage insulation technique, in particular in outdoor power stations, substation and electrical equipment. Originally, ceramic-based hollow-core insulators were essentially used; meanwhile, hollow-core composite insulators are increasingly being used.

Hollow core insulators are usually made of a hollow-wound inner tube or body, upper and lower flanges and silicone rubber shed, which provides support and insulation for wires and electrical equipment.

The body of these hollow core insulators are usually filled with nitrogen or sulfur hexafluoride as an electrically insulating material to avoid internal flashover. However, firmly sealing these gases within the insulating system over a long period of time as well as over variable temperatures is difficult. The use of these gaseous dielectrics requires a sophisticated monitoring system in order to detect any leaks in the hollow core insulator during operation. Otherwise, gas pressure drops, moisture may penetrate into the hollow core insulator, and the dielectric strength of the insulation system decreases. Further, the fluorine-containing compound sulfur hexafluoride is one of the greenhouse gases and is therefore extremely questionable from an ecological point of view.

However, the gas cannot simply be replaced by another electrically insulating material, since due to the large dimensions of high-voltage insulators, which can be up to 10 m in length, the use of a conventional solid dielectric material would lead to an extremely high total weight of the insulator, which would not be practical for the above-mentioned applications.

To resolve this problem, the use of dielectric foams has been proposed. For example, WO2021/058500 discloses the use of dry syntactic foams based on poly (acrylonitrile-co-vinylidene chloride-co-methyl methacrylate) hollow microspheres as an ultra-lightweight filler in hollow core insulators. However, these foams contain substantial amounts of halogens which makes them not environmentally friendly products.

WO2011/089471 discloses filling the hollow core of insulators with an insulating material selected from closed cell polyethylene foams, crosslinked polyethylene foams, EVA forms, polystyrene foams, and closed-cell non-halogen polyurethane foams. The polyurethane foams are the most preferred. The authors are however silent on the composition of these polyurethane foams.

Polyurethane foams are well known and used in a variety of applications. They can be produced by the reaction of a polyisocyanate with a polyol in the presence of various additives. Polyurethane foams offer a wide variety of physical properties, as well as the desirable dielectric properties for use in insulation systems. Furthermore, the lightness of the polyurethane foam encourages its application in high voltage insulation. In comparison with the traditionally used gases, polyurethane foams allow for a much easier seal in insulation systems and eliminates the potential risk of gas leakage.

US2018/0051124 discloses polyurethane foams for use in high voltage resin impregnated paper bushings to fill the gap between the condenser core and the outer hollow insulator. The polyurethane foams are prepared from (A) a polyol composition comprising a polyether polyol, a polyolefin polyol, and a polyester polyol obtainable by epoxidation of an unsaturated fatty acid ester and subsequent ring-opening reaction with a compound containing active hydrogen, and (B) a polyisocyanate compound. While this composition is very useful as foam for high voltage-bushings, it is somehow over-engineered and hence too costly for use in larger volume applications, such as filling of hollow core insulators. Further, the composition comprises a polyolefin polyol, in particular a polybutadiene-based polyol, which is falling under the chemical weapons convention and hence cannot be used globally. In addition, some of the components used in this composition, such as Sovermol 1111, are not REACH registered by the manufacturer and are hence no longer available.

Therefore, there is a need to provide a new polyurethane foam, suitable for filling hollow core insulators, based on a composition wherein all the components are available and wherein none of them falls under the chemical weapons convention.

There is also a need to provide a new polyurethane foam for filling hollow core insulators which is more environmentally friendly, in particular which is free of halogens, and preferably with a higher renewable raw material content, thus a lower carbon footprint.

It is also desirable that the new polyurethane foam be cost-effective for filling of large volumes of hollow core insulators.

Another important factor is providing a composition that is storage stable. Indeed, the two constituents, the polyol compound and the polyisocyanate component, are usually mixed shortly before the generation of the polyurethane foam. Since the polyol compound frequently contains several polyols as well as various additives dispersed therein, these mixtures often tend to precipitation of solid components. Therefore, the storage stability of the polyol component is a requirement to be met.

The applicant has surprisingly found that such polyurethane foams can be prepared from (A) a polyol composition comprising at least one or more polyether polyols having an average functionality of greater than 2, castor oil, one or more mineral oil and one or more foam stabilizing agent and (B) a polyisocyanate component having an average functionality of greater than 2.

This composition makes it possible to circumvent all the drawbacks of the prior art compositions but also makes it possible, in an unexpected way, to prepare polyurethane foams with improved properties.

### SUMMARY OF THE INVENTION

The present invention relates to a polyol composition (A), comprising, based on the total weight of the composition:
a1) from 35% to 90% by weight of one or more polyether polyols having an average hydroxyl functionality of greater than 2,
a2) from 10% to 50% by weight of castor oil,
a3) from 5% to 30% by weight of one or more mineral oil,
a4) from 0.05% to 10% by weight of one or more foam stabilizing agent, wherein at least 80% by weight of the total weight of polyols in the composition is provided by the polyether polyol a1) and the castor oil a2).

Advantageously, the polyether polyol a1) is selected from linear or branched polyethylene oxide, polypropylene oxide, a hydroxy-terminated ethylene oxide/propylene oxide block copolymer and mixtures thereof.

According to a preferred embodiment, the polyether polyol is a mixture of a polyether polyol having a hydroxyl number inferior or equal to 200 mg KOH/g, and a polyether polyol having a hydroxyl number greater than 200 mg KOH/g.

Advantageously, the mineral oil a3) is a naphthenic mineral oil.

According to a preferred embodiment, the polyether polyol a1) comprises from 5% to 20% by weight of one or more a polyether polyol having a hydroxyl number greater than 200 mg KOH/g and from 30% to 70% by weight of one or more polyether polyols having a hydroxyl number inferior or equal to 200 mg KOH/g, based on the total weight of the composition.

Advantageously, the polyol composition according to the invention further comprises additives selected from epoxy-components, rheological modifiers, surface-active substances, flame retardants, fillers, catalysts, drying agents, dyes, pigments, flameproofing agents, softening agents, thermal aging stabilizers, thixotropic agents, blowing agents and their mixture.

Advantageously, the epoxy-component is a polypropylenglycol diglycidyl ether.

Advantageously, the rheological modifier is fumed silica.

According to a preferred embodiment, the polyol composition (A) according to the invention is free of polyolefin polyols. The present invention further relates to a two-constituent composition comprising at least:
a component (A) which is a polyol composition as described above,
a component (B) which is a polyisocyanate having an average NCO functionality greater than 2.

Advantageously, the component (B) comprises at least methyl diphenyl diisocyanate.

Advantageously, the molar ratio of the NCO groups of component (B) to the sum of the reactive hydrogen atoms in the component (A) ranges from 0.80:1 to 1.75:1.

The invention also relates to a polyurethane foam obtained by reacting the polyol composition (A) and the component (B) of the composition as described above in particular, in presence of a blowing agent.

The invention also relates to the use of a composition for filling hollow core insulators, the composition comprising at least:
a component (A) which is a polyol composition comprising, based on the total weight of the composition:
a1) from 35% to 90% by weight of one or more polyether polyols having an average hydroxyl functionality of greater than 2,
a2) from 10% to 50% by weight of castor oil, wherein at least 80% by weight of the total weight of polyols in the composition is provided by the polyether polyol a1) and the castor oil a2), a component (B) which is a polyisocyanate with an average NCO functionality of greater than 2.

The invention also relates to a hollow core insulator filled with a polyurethane foam obtained by reacting
a component (A) which is a polyol composition comprising, based on the total weight of the composition:
a1) from 35% to 90% by weight of one or more polyether polyols having an average hydroxyl functionality of greater than 2,
a2) from 10% to 50% by weight of castor oil,
wherein at least 80% by weight of the total weight of polyols in the composition is provided by the polyether polyol a1) and the castor oil a2),
a component (B) which is a polyisocyanate with an average NCO functionality of greater than 2.

### DETAILED DESCRIPTION

The term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

### The Polyol Composition (A)

A first object of the invention consists in a polyol composition (A) for preparing polyurethane foams, the polyol composition comprising, based on the total weight of the composition:
a1) from 35% to 90% by weight of one or more polyether polyol having an average functionality of greater than 2,
a2) from 10% to 50% by weight of castor oil,
a3) from 5% to 30% by weight of one or more mineral oil,
a4) from 0.05% to 10% by weight of one or more foam stabilizing agent,
wherein at least 80% by weight of the total weight of polyols in the composition is provided by the polyether polyol a1) and the castor oil a2).

Preferably, at least 90% by weight, more preferably at least 95% by weight, most preferably 98% by weight of the total weight of polyols in the polyol composition (A) is provided by the polyether polyol a1) and castor oil a2). Advantageously, the polyol composition (A) according to the invention is free of polyolefin polyols.

By “free of polyolefin polyols” is meant a polyol composition comprising less than 5% by weight, preferably less than 2% by weight, more preferably less than 1% by weight of one or more polyolefin polyol, based on the total weight of the polyol composition. In particular, polyolefin polyols can be selected from polyisoprene polyol, polybutadiene polyol, hydroxyl-terminated polybutadiene-acrylonitrile, hydroxyl-terminated styrene-butadiene liquid rubber or hydrogenated hydroxyl-terminated polybutadiene.

In a preferred embodiment, the polyol composition (A) according to the invention is free of polyisoprene polyol and/or polybutadiene polyol.

Advantageously, the compounds a1), a2), a3) and a4) represents at least 80% by weight, preferably at least 90% by weight, most preferably at least 95% by weight, most preferably at least 98% by weight of the polyol composition (A).

Advantageously, the polyol composition (A) according to the invention consists, based on the total weight of the composition, essentially of:
a1) from 35% to 90% by weight of one or more polyether polyol having an average functionality of greater than 2,
a2) from 10% to 50% by weight of castor oil,
a3) from 5% to 30% by weight of one or more mineral oil,
a4) from 0.05% to 10% by weight of one or more foam stabilizing agent.

Advantageously, the polyol composition according to the invention further comprises one or more additives a5) selected from those usually used in the preparation of polyurethane foams.

The applicant has found that the polyol compositions according to the invention remain stable when stored over long periods, for example, up to one month, preferably up to 6 months, more preferably up to 12 months.

The applicant has also surprisingly found that the specific choice of this polyol composition makes it possible to produce polyurethane foams with lower reaction enthalpy and longer reaction times when compared with prior art compositions. These advantages are particularly interesting in the case of the use of the polyurethane foam for filling large volumes of insulator systems, in particular hollow core insulators.

In addition, it has been found that the polyurethane foam prepared from the polyol composition according to the invention is very soft and shows a low-temperature flexibility which are also desired characteristics for the application as filler of hollow core insulators.

### a1) the Polyether Polyols

The polyether polyols suitable for the polyol composition according to the invention may be selected from polyether polyols based on ethylene oxide, polyether polyols based on propylene oxide, corresponding ethylene oxide/propylene oxide copolymers which can be either random or block copolymers, and mixtures of these polyether polyols. The ratio of ethylene oxide to propylene oxide in the ethylene oxide/propylene oxide copolymers can vary within wide limits. Thus, for example, it is possible for only the terminal hydroxyl of the polyether polyols to be reacted with ethylene oxide.

According to an embodiment, the polyether polyol is a linear or branched polyethylene oxide or polypropylene oxide or a mixture thereof.

According to another embodiment, the polyether polyol is a hydroxy-terminated ethylene oxide/propylene oxide block copolymer.

According to another embodiment, the polyether polyol is a mixture of a linear or branched polyethylene oxide and/or polypropylene oxide and a hydroxy-terminated ethylene oxide/propylene oxide block copolymer.

The polyether polyol used in the polyol composition according to the invention has an average hydroxyl functionality of greater than 2. Preferably, the polyether polyol has an average hydroxyl functionality ranging from 2.5 to 4, preferably from 2.5 to 3.5. According to a favorite embodiment, the polyether polyol has an average hydroxyl functionality of 3.

These polyether polyols can be obtained, for example, by reacting one or more polyfunctional active hydrogen initiators with alkylene oxides such as ethylene oxide, propylene oxide, butylene oxide, tetrahydrofuran and mixtures thereof, preferably propylene oxide, ethylene oxide and/or mixed propylene oxide and ethylene oxide. The polyfunctional active hydrogen initiators are all those usually used for the preparation of polyether polyols having a functionality greater than 2, preferably between 2 and 4, for example water, aliphatic, cycloaliphatic or aromatic polyhydroxy compounds having 2 or 3 hydroxy groups, such as ethylene glycol, propylene glycol, butanediols, hexanediols, octanediols, dihydroxy benzenes or bisphenols, trimethylolpropane or amines. The method for preparing the polyether polyols is known to the skilled person and is described, for example, in Ullmann's Encyclopedia of Industrial Chemistry, 4^{th} Edition, Volume 19, 1980, pages 31-38, 304 and 305).

Polytetrahydrofurans may also be used and are commercially available, for example, under the trade name POLYMEG®.

Advantageously, the polyether polyols according to the invention have a molecular weight ranging from 100 to 2000 g/mol, preferably from 200 to 1000 g/mol and more preferably from 300 to 600 g/mol.

Advantageously, the polyol composition according to the present invention comprises 40% to 80% by weight of one or more polyether polyols with respect to the total weight of the polyol composition (A).

According to a favorite embodiment of the present invention, the polyether polyol is a mixture of one or more polyether polyol having a high hydroxyl number and one or more polyether polyol having a low hydroxyl number.

As used herein, the term “hydroxyl number” refers to the number of milligrams of potassium hydroxide equivalent to the hydroxyl content in one gram of the polyether polyol, determined by the test method DIN 53240-2. The hydroxyl number unit is expressed in mg KOH/g of polyether polyol.

By “polyether polyol having a low hydroxyl number” is meant a polyether polyol having a hydroxyl number inferior or equal to 200 mg KOH/g, preferably within the range of 10 to 200 mg KOH/g, more preferably from 15 to 100 mg KOH/g, most preferably from 20 to 50 mg KOH/g.

By “polyether polyol having a high hydroxyl number” is meant a polyether polyol having a hydroxyl number greater than 200 mg KOH/g, preferably within the range of 250 to 500 mg KOH/g, preferably from 300 to 450 mg KOH/g.

Advantageously, the polyol composition according to the invention comprises from 5% to 20% by weight, preferably from 8% to 15% by weight of one or more polyether polyol having a high hydroxyl number and from 30% to 70% by weight, preferably from 40% to 60% by weight of one or more polyether polyol having a low hydroxyl number.

In a preferred embodiment, the polyether polyol is a mixture of one or more polyether polyol having an average functionality of 3 and a hydroxyl number comprised between 300 and 450 mg KOH/g and one or more polyether polyol having an average functionality of 3 and a hydroxyl number comprised between 20 and 50 mg KOH/g.

According to a most favorite embodiment, the polyether polyol comprises from 5% to 20% by weight of one or more polyether polyol having a hydroxyl number comprised between 300 and 450 mg KOH/g and from 30% to 70% by weight of one or more polyether polyol having a hydroxyl number comprised between 20 and 50 mg KOH/g, based on the total weight of the polyol composition (A).

### a2) Castor Oil

An important aspect of the present invention is the use of renewable natural components. This is achieved by using castor oil in the polyol composition.

Castor oil is a natural oil polyol derived from castor beans. Chemically, it is a triglyceride wherein the three hydroxyl groups of glycerol have been esterified mainly with 12-hydroxyoctadeca-9-enoic acid as fatty acid, known as ricinoleic acid.

Preferably, the castor oil according to the invention is a non-modified castor oil.

By “a non-modified castor oil” is meant a castor oil which has not undergone any treatment process other than purification.

Preferably, the castor oil according to the present invention has an average functional group number of from 2.0 to 2.7, more preferably from 2.2 to 2.7.

Preferably, the castor oil according to the present invention has an average hydroxyl number ranging from 30 to 170 mg KOH/g, more preferably from 100 to 160 mg KOH/g.

Preferably, the polyol composition according to the invention comprises from 15% to 40% by weight of castor oil with respect to the total weight of the polyol composition (A).

Advantageously, the weight ratio of polyether polyol(s) to castor oil is ranging from 10:1 to 1:5, preferably from 5:1 to 1:1 and most preferably from 4:1 to 1:1.

### a3) the Mineral Oil

The mineral oil according to the invention is advantageously selected from aliphatic, cycloaliphatic, and branched aliphatic saturated hydrocarbons distilled from petroleum that contain from 5 to 24 carbon atoms, preferably from 5 to 18 carbon atoms.

Preferably the mineral oil is selected from naphthenic and paraffin oils. According to a preferred embodiment, the mineral oil is a naphthenic oil.

Advantageously, the mineral oil has a viscosity ranging from 50 to 200 cSt at 40° C., preferably from 70 to 150 cSt at 40° C., more preferably from 80 to 120° C. cSt at 40° C. according to ASTM 445.

Advantageously, the polyol composition according to the invention comprises from 7% to 20% by weight of mineral oil with respect to the total weight of the polyol composition (A).

Preferably the polyol composition according to the invention comprises from 7% to 20% by weight of naphthenic oil with respect to the total weight of the polyol composition (A).

### a4) the Foam Stabilizing Agent

The polyol composition according to the invention comprises a foam stabilizing agent.

The foam stabilizing agent can be selected from the group of polydimethylsiloxanes, organofunctional polydimethylsiloxanes, siloxane polyether copolymers, block-copolymers with silicone and organic blocks and mixtures thereof.

According to a preferred embodiment, the foam stabilizing agent is selected from the group of polyether modified polysiloxanes, in particular polysiloxane-polyoxyalkylene block-copolymers. These stabilizing agents are described, for example, in U.S. Pat. No. 6,166,098 and EP-A 936 240, and are commercially available, under the trade names TEGOSTAB®.

According to another preferred embodiment, the foam stabilizing agent is selected from the group of block-copolymers with silicone and organic blocks, the organic blocks, for example, being based on caprolactone or other lactones, such as Genioperl® W35 (Wacker Chemie AG, Munich, Germany),

Advantageously, the foam stabilizing agent represents from 0.5% to 8% by weight, more preferably from 1% to 6% by weight based on the total weight of the polyol composition (A).

### a5) Further Additives

Additives are compounds added in small quantities that promote improvements in the polyol composition and/or in the polyurethane foams prepared therefrom.

Advantageously, the polyol composition according to the invention comprises further optional additives selected from epoxy-components, catalysts, surface-active substances, drying agents, fillers, dyes, pigments, flameproofing agents, softening agents, thermal aging stabilizers, thixotropic or rheological modifier agents, blowing agents and mixtures thereof.

Suitable catalysts are, for example, tertiary amines such as N-methyldiethanolamine, triethylenediamine, triethanolamine, penthamethyldiethylenetriamine, tetramethylethylenediamine, dibenzyl methylamine, N-ethylmorpholine, N-methylmorpholine, 1-methyl-4-dimethylamine ethylpiperazine, N,N-diethyl-3-diethylamine propylamine, 1-(2-hydroxypropyl)imidazole or diazabicyclooctane or organotin compounds such as dibutyltin laurate.

Suitable flameproofing agents can be selected from a phosphate compound such as tricesyl phosphate or dimethylmethane phosphonate, a halogenated compound, a non-halogenated compound, or a combination thereof. Preferably, the flameproofing agent is selected from phosphate compounds, non-halogenated compounds and their mixture. Inorganic flame retardants such as hydrated aluminum oxide, antimony trioxide and ammonium polyphosphate can be used as well.

Suitable thermal aging stabilizers for the polyol composition according to the invention can be, for example, aliphatic glycidyl ethers such as polypropylene glycol digylcidyl ether.

Suitable fillers, can be selected, for example, from particles, such as carbonates, alumine and silica, as well as natural and synthetic fibers, or mixtures thereof.

The total content of additives in the polyol composition according to the invention is advantageously ranging from 0.01% to 30% by weight, preferably from 0.05% to 10% by weight, based on the total weight of the polyol composition (A).

According to a favorite embodiment, the polyol composition according to the invention comprises a thixotropic or rheological modifier agent which is fumed silica. Preferably, the fumed silica is a hydrophilic or hydrophobic fumed silica having a specific surface area of from 120 to 280 m²/g. Preferably, the polyol composition according to the invention comprises from 0.01% to 5% by weight of fumed silica based on the total weight of the polyol composition (A).

According to a favorite embodiment, the polyol composition according to the invention comprises an epoxy component. Preferably, the epoxy component is polypropylenglycol diglycidyl ether. Preferably, the polyol composition according to the invention comprises from 0.01% to 5% by weight of epoxy component based on the total weight of the polyol composition (A).

It is to be emphasized that the invention encompasses any combination of any specific compound or group of compounds as mentioned hereinabove for components a1), a2), a3) and a4).

According to a preferred embodiment, the polyol composition according to the invention comprises, preferably consists essentially of:
from 35% to 90% by weight of a polyether polyol having an average hydroxyl functionality ranging from 2.5 to 4, preferably from 2.5 to 3.5,
from 10% to 50% by weight of castor oil,
from 5% to 30% by weight of a mineral oil, preferably naphthenic mineral oil,
from 0.05% to 10% by weight of a foam stabilizing agent, and
optionally, from 0.01% to 5% by weight of further additives chosen from the group of epoxy components, catalysts, surface-active substances, drying agents, fillers, dyes, pigments, flameproofing agents, softening agents, thermal aging stabilizers, thixotropic or rheological modifier agents, blowing agents and mixtures thereof.

According to a most preferred embodiment, the polyol composition according to the invention comprises, preferably consists essentially of:
from 5% to 20% by weight of a polyether polyol having a hydroxyl number greater than 200 mg KOH/g, preferably within the range of 250 to 500 mg KOH/g, preferably from 300 to 450 mg KOH/g,
from 30% to 70% by weight of a polyether polyol having a hydroxyl number inferior or equal to 200 mg KOH/g, preferably within the range of 10 to 200 mg KOH/g, more preferably from 15 to 100 mg KOH/g, most preferably from 20 to 50 mg KOH/g,
from 10% to 50% by weight of castor oil,
from 5% to 30% by weight of a mineral oil, preferably naphthenic mineral oil,
from 0.05% to 10% by weight of a foam stabilizing agent, and
optionally, from 0.01% to 5% by weight of further additives chosen from the group of epoxy components, catalysts, surface-active substances, drying agents, fillers, dyes, pigments, flameproofing agents, softening agents, thermal aging stabilizers, thixotropic or rheological modifier agents, blowing agents and mixtures thereof.

Advantageously, the polyol composition (A) according to the invention has a viscosity at 25° C. ranging from 1000 to 3000 mPa.s, preferably from 1500 to 2500 mPa.s.

### The Curable Two-Constituent Composition

In producing the polyurethane foam according to the invention, the polyol composition (A) described above is reacted with a polyisocyanate component (B).

Therefore, another aspect of the present invention is to provide a two-constituent curable composition comprising the polyol composition (A) as described above and one or more polyisocyanate component (B) having an average NCO functionality of greater than 2.

By “two-constituent composition” is meant a composition comprising the polyol composition and the polyisocyanate component, these two components being provided as two pack systems (or kit), where the polyol composition (A) is part (1) and the polyisocyanate is part (2). Such a composition in two parts is designed for extemporaneous mixing of the two compositions for polyurethane foam formation shortly before curing.

By “curable composition” is meant a composition comprising the polyol composition (A) and the polyisocyanate component (B) that, when these two constituents are mixed/blended together and cured, can form a cured solid polyurethane by forming chemical bonds called crosslinks.

### The Polyisocyanate Component (B)

The polyisocyanate components useful in producing polyurethane foams according to the present invention are well known in the art and are organic compounds that contain greater than two isocyanate groups per molecule. Polyisocyanate components may be aromatic, cycloaliphatic or aliphatic and may be monomeric or oligomeric compounds.

Advantageously, the polyisocyanate component has a NCO functionality greater than or equal to 2, preferably ranging from 2.1 to 3.2.

The isocyanate “functionality” is the number of reactive NCO groups per molecule in an isocyanate molecule or in a polymeric isocyanate. For example, most polyisocyanates, in particular MDI-type polyisocyanate compounds, contain a blend of monomeric and polymeric MDI, and the isocyanate functionality is an average functionality across the different molecular and polymeric species. As used herein, “MDI” refers to methylene diphenyl diisocyanate, also called diphenylmethane diisocyanate, and the isomers thereof. MDI exists as one of three isomers (4,4′ MDI, 2,4′ MDI, and 2,2′ MDI), or as a mixture of two or more of these isomers. Unless specifically stated otherwise, “MDI” may also refer to, and encompass, polymeric MDI. Polymeric MDI is a compound that has a chain of three or more benzene rings connected to each other by methylene bridges, with an isocyanate group attached to each benzene ring.

Suitable polyisocyanate component (B) according to the invention can be selected from dodecane-1,12-diisocyanate, 2-ethyltetramethylene-, 1,4-diisocyanate, 2-tetramethylene-1,4-diisocyanate, methylpentamethylene-1,5-diisocyanate, hexamethylene-1,6-diisocyanate, cyclohexane-1,3-diisocyanate, cyclohexane-1,4-diisocyanate, isophorone diisocyanate, hexahydrotoluene-2,4-diisocyanate, hexahydrotoluene-2,5-diisocyanate, dicyclohexylmethane-2,2′-diisocyanate, dicyclohexylmethane-2,4′-diisocyanate, dicyclohexylmethane-4,4′-diisocyanate, toluene-2,4-diisocyanate, toluene-2,6-diisocyanate, diphenylmethane-2,2′-diisocyanate (2,2′-MDI), diphenylmethane-4,4′-diisocyanate (4,4′-MDI), diphenylmethane-2,4′-diisocyanate (2,4′-MDI) polyphenylpolymethylene polyisocyanates (crude MDI), and mixtures thereof.

Commercially available diisocyanates often contain dimeric (uretdiones), trimeric (triazines) and oligomeric compounds. In the compositions according to the invention these mixtures of monomers and oligomers can be employed without separation of byproducts or purification.

According to a preferred embodiment of the present invention, the polyisocyanate component (B) is selected from methylene diphenyl diisocyanate (MDI) including any or all isomers thereof, polymeric methylene diphenyl diisocyanate and/or mixtures thereof.

According to a most preferred embodiment, the polyisocyanate component (B) comprises 2,2′-methylene diphenyl diisocyanate (2,2′-MDI), 4,4′-methylene diphenyl diisocyanate (4,4′-MDI), and polymeric methylene diphenyl diisocyanate.

### Polyurethane Foam Formation

A further object of the invention is providing improved polyurethane foams obtained by mixing and curing the two-constituent curable composition as described above.

The polyurethane foams of the invention can be prepared in the conventional manner, in particular by mixing and/or blending the two constituents together.

In accordance with a preferred mode of preparing such polyurethane foams, the polyol composition (A) and the polyisocyanate component (B) are reacted in such amount that the molar ratio of the NCO groups of the polyisocyanate component (B) to the sum of the reactive hydrogen atoms of the components (A) is ranging from 0.85:1 to 1.75:1, preferably from 0.8:1 to 1.3:1, more preferably from 1.0:1 to 1.2:1. This corresponds to a ratio ranging respectively from 85% to 175%, preferably from 80% to 120%, more preferably from 100% to 130%, most preferably from 100% to 120% of the stoichiometric ratio.

By “the reactive hydrogen atoms of the components (A)” is meant the sum of the reactive hydrogen atoms provided by the polyols contained in the polyol composition (A), in particular, by at least the polyether polyol a1) and the castor oil a2).

In general, a blowing agent is added and/or provided during the polyurethane forming reaction. The blowing agent may be air, nitrogen, argon, carbon dioxide or any other inert gas. The blowing agent may also be water, which reacts with isocyanate to generate carbon dioxide in situ, or a fluorinated hydrocarbon such as dichlorodifluoromethane, 1,1-dichloro-1-fluoroethane, 1-chloro-1,1-difluoroethane, 2,2-dichloroethane or the like. Non-fluorinated organic compounds such as pentane and acetone may also be employed as blowing agents.

According to a preferred embodiment, the polyurethane foam according to the invention is prepared by reacting the polyol composition (A) and the polyisocyanate component (B) in presence of a blowing agent selected from air, nitrogen, carbon dioxide or mixtures thereof. The amount of blowing agent required can vary according to the desired density of the foam. Suitable levels of blowing agent are known to the skilled person. According to a preferred embodiment, the blowing agent is used in an amount such as to obtain a density of polyurethane foam ranging from 100 kg/m³ to 700 kg/m³.

According to a most preferred embodiment, the blowing agent is air and is provided during mixing/blending of the two-constituent composition, for example, by stirring the mixture at from 1,500 to 10,000 rpm for from 10 to 30 seconds. These stirring conditions are sufficient to introduce air to achieve the foam formation.

Advantageously, when mixed together, the polyol composition and the polyisocyanate according to the invention form a composition, before being cured, having a viscosity at 25° C. ranging from 1000 to 2000 mPa.s, preferably from 1200 to 1800 mPa.s. For example, the viscosity can be measured 10 to 15 minutes after mixing the polyol composition and the polyisocyanate according to the invention.

Advantageously, after mixing/blending the components (A) and (B) as described above, the obtained foam is cured.

The applicant has found that the inventive two-constituent composition according to the invention has a slow curing reaction and thus a low reactivity, and can be cured at a relatively low temperature.

Advantageously, the polyurethane foam is cured at a temperature ranging from 10 to 50° C., preferably from 20 to 40° C.

Advantageously, the polyurethane foam is cured for a period of time ranging from 15 minutes to 96 hours, preferably from 30 minutes to 72 hours.

Advantageously, when mixed together to form a polyurethane foam, the polyol composition (A) and the polyisocyanate component (B) according to the invention form a composition that reaches 5 Pa.s at 25° C. in a time period greater than or equal to 40 minutes, preferably greater than or equal to 45 minutes.

The low reactivity of the composition according to the invention is also characterized by higher gel time with respect to the prior art compositions. In particular, the gel time preferably occurs more than 200 minutes, preferably more than 300 minutes, more preferably more than 400 minutes after mixing the polyol composition and the polyisocyanate according to the invention at 25° C.

Preferably, the gel time occurs more than 120 minutes, preferably more than 160 minutes, more preferably more than 200 minutes after mixing the polyol composition and the polyisocyanate component according to the invention at 40° C.

Preferably, the gel time occurs more than 60 minutes, preferably more than 90 minutes, more preferably more than 100 minutes after mixing the polyol composition and the polyisocyanate according to the invention at 60° C.

Because the composition according to the present invention has a low viscosity before being cured, has the ability to get cured at a relatively low temperature and has a low reactivity, the composition is easy to handle and can be applied to the hollow core insulators and be cured therein easily.

Advantageously, the polyurethane foam according to the invention has a Shore hardness (A) less than or equal to 60, preferably less than or equal to 50, more preferably between 20 and 50.

Advantageously, the polyurethane foam according to the invention has a density ranging from 250 to 500 kg/m³ preferably a density of about 400 kg/m³.

Advantageously, the polyurethane foam according to the invention has a Tan delta as measured according to IEC62631 Feb. 1 comprised between 5 and 20% at 23° C.

Advantageously, the polyurethane foam according to the invention has a dielectric constant comprised between 5 and 12, preferably between 6 and 10 F/m.

Advantageously, the polyurethane foam according to the invention has a volume resistivity comprised between 5*10⁹ and 5*10¹² Ω.cm.

Advantageously, the polyurethane foam according to the invention has a specific reaction enthalpy comprised between 40 J/g and 50 J/g.

### Use of the Composition According to the Invention

According to another aspect, the invention relates to the use of a two-constituent composition and/or the polyurethane foam prepared therefrom for filling hollow core insulators, in particular the body of hollow core insulators, the composition comprising at least:
a component (A) which is a polyol composition comprising, based on the total weight of the polyol composition:
a1) from 35% to 90% by weight of one or more polyether polyols having an average hydroxyl functionality of greater than 2,
a2) from 10% to 50% by weight of castor oil,
wherein at least 80% by weight of the total weight of polyols in the composition is provided by the polyether polyol a1) and the castor oil a2), and
a component (B) which is a polyisocyanate having an average NCO functionality of greater than 2.

The hollow core insulator filled with the polyurethane foam as described in details above is advantageously manufactured by a process comprising at least the following steps:
providing a hollow core insulator,
providing a two-constituent composition comprising at least the polyol composition (A) which is a polyol composition comprising, based on the total weight of the polyol composition:
a1) from 35% to 90% by weight of one or more polyether polyols having an average hydroxyl functionality of greater than 2,
a2) from 10% to 50% by weight of castor oil,
wherein at least 80% by weight of the total weight of polyols in the composition is provided by the polyether polyol a1) and the castor oil a2), and
a polyisocyanate component (B) which is a polyisocyanate having an average NCO functionality of greater than 2,
reacting the two constituents, in particular in presence of a blowing agent, to produce a polyurethane foam,
filling the body of the hollow core insulator with the polyurethane foam,
curing the polyurethane foam in the hollow core insulator.

According to favorite embodiments of the use according to the invention, the polyol composition (A) corresponds to the above disclosure in the chapter “The polyol composition (A)”.

According to favorite embodiments of the use according to the invention, the polyisocyanate component (B) corresponds to the above disclosure in the chapter “The curable two-constituent composition”.

The body of the hollow core insulator may be filled with the polyurethane foam by spraying, pouring or injecting the foam into the body. It is to be understood that during the filling of the body of the hollow core insulator, the foam is still in a manageable uncured form that allows filling of the hollow core insulator.

In alternative embodiments, the body can be filled with a combination of a polyurethane foam according to the invention and one or more other insulating foam materials such as an insulating gas, such as SF₆.

The body of the hollow core insulator can have any suitable degree of filling. Advantageously, at least 70% by volume, preferably at least 90% by volume of the body is filled with the polyurethane foam according to the invention. According to a particularly preferred embodiment of the present invention, the body of the hollow core insulator is completely filled with the polyurethane foam, i.e. the degree of filling of the body is at least 95% by volume, preferably 100% by volume.

Advantageously, the polyurethane foam is cured at a temperature ranging from 10 to 50° C., preferably from 20 to 40° C. to obtain a cured polyurethane foam. Preferably, the polyurethane foam is cured at ambient temperature.

Advantageously, the polyurethane foam is cured for a period of time ranging from 15 minutes to 96 hours, preferably from 30 minutes to 72 hours.

Advantageously, the cured polyurethane foam according to the invention has a glass transition temperature of less than −40° C., preferably between −40° C. and −70° C.

The polyurethane foam according to the invention may be also applied as low-temperature flexible, low-stress encapsulation system for electronical parts.

According to another aspect, the invention relates to a hollow core insulator filled with a polyurethane foam prepared by reacting the polyol composition (A) as described above and the polyisocyanate component (B) as described above.

Suitable hollow-core insulators include, but are not limited to, composite insulators, porcelain insulators, and hybrid insulators.

In addition to the polyurethane foam according to the invention, the hollow core insulator can optionally also include other electrically insulating materials, such as nitrogen or sulfur hexafluoride.

### EXAMPLES

In the following examples, and unless otherwise indicated, the contents and percentages are given in mass.

### I-Raw Materials

### I-1) Polyether Polyols:

Baygal K 55 supplied by Bayer. This is a trifunctional polyether polyol with a viscosity of about 600 mPas and a hydroxyl nr. of 370-400 mg KOH/g.
Lupranol 2007/1 supplied by BASF. This a trifunctional highly reactive polyether polyol with primary hydroxyl end groups. It has viscosity of about 1227 mPas and a hydroxyl nr. of 27 mg KOH/g (DIN 53 240).
Lupranol 2095 supplied by BASF. This is a trifunctional polyether polyol with primary hydroxyl end groups. It has viscosity of about 850 mPas and a hydroxyl nr. of 35 mg KOH/g (DIN 53 240).

### I-2) Polyolefin Polyol (Comparative):

Polybd R45 HTLO supplied by SARTOMER. This is a hydroxyl terminated polybutadiene with a viscosity of 5 Pas at 30° C., a hydroxyl functionality of 2.5 and a molecular weight Mn of 2800 g/mol. The 1,2 vinyl-content is 20%.

### I-3) Polyester Polyols:

Castor oil supplied by Nidera Handelscompagnie BV.
Sovermol 1111 supplied by BASF (comparative). This is a branched polyetherester with a viscosity of 300-700 mPas at 25° C. (DIN 53015). According to document “From vegetable oils to polyurethanes: synthetic routes to polyols and main industrial products” in “Polymers Review” journal (manuscript LMSC-2011-0133.R1) these materials are resulting from epoxidation of natural oils followed by ring-opening of epoxides by nucleophilic attack of an alcohol (CH₃OH for instance). Then, in a third step, hydoxylated oils undergo transesterification with the same alcohol.

### I-4) Mineral Oil:

Nyflex 820 supplied by Nynas GmbH. A severely Hydrotreated Process Oil with a viscosity of 90-110 cSt at 40° C. (ASTM 445).

### I-5) Foam Stabilizing Agent:

TEGOSTAB B 8863 Z supplied by Evonik. This is a polyether modified Polysiloxan.

### I-6) Polyisocyanate

Suprasec 2447 supplied by Huntsman Polyurethanes.

### I-7) Other Additives:

HR 1862 (DY 3601) supplied by Huntsman. This is a polypropylene-glycol-diglycidylether with an Epoxy index of 2.47-2.60 eq/kg (ISO 3001).
Cab-O-sil M5 supplied by Cabot Specialty Chemicals, and Aerosil 200 supplied by Evonik. These are fumed silicas.

### II—Preparation of polyol composition (A)

All components of each composition of examples shown in Table 1 with exception of the polyisocyanate component Suprasec 2447 were put to into a metal can of sufficient size in the given proportion to result in 200 g of polyol composition mixture. The mixture was then prepared by stirring the components at 23° C. with a propeller stirrer for about 2 minutes, resulting in polyol composition (A).

Example 1 is according to the invention.

Example 2 is comparative and corresponds to example 1 according to the disclosure of US2018/0051124.

### III—Preparation of the Reactive Mixture of Polyol Composition (A) and Polyisocyanate (B)

About 150 g of the component A and the corresponding amount of component B according to Table 1 were put into a metal can and then mixed at ambient temperature with a propeller stirrer for 2 minutes. 80 g of this reactive mixture was then subsequently used to produce foam and the rest to test the gel time and produce the plates for tan delta and other tests as described in the following.

### IV—Production of the Polyurethane Foam

80 g of polyol/isocyanate mixture were put into a 200 ml cup and then stirred with a small high shear disperser mixer for 30 seconds at 2000 rpm. This shearing with this equipment is sufficient to introduce such amount of air to achieve about 30% volume increase due to foam formation. The generated foam is then let curing at 23° C. for 72 hours. The aspect of the cured foam sample was then checked on homogeneity. The requirement to pass this foam stability test is to show no signs of collapse.

### V—Properties Measurement Tests

### Storage Stability of the Polyol Composition (A):

Storage stability was evaluated over a period of 1 month at room temperature. The composition is considered stable if it remains homogenous with no signs of separation. A composition showing incompatibility of components normally displays more than one phase after some time.

### Viscosity Measurement:

The polyol composition (A) and the mixture of components A and B were subjected to Rheomat viscosimeter and the development of viscosity was followed up to 5 Pas were reached. The time needed to achieve 5 Pas was recorded. The viscosity was measured according to DIN 53019.

### Tan Delta and Tg Measurement:

The dielectric loss factor Tan delta was determined according to international standard IEC 62631-2-1. The mixture of component A and B was cast (without foaming) into moulds and 1 mm and 2 mm thick plates were produced by letting the mixture cure for 4 hours at 90° C. The tan delta was then measured on the 2 mm thick plates. The glass transition temperature Tg was measured by DSC starting at −80° C. and the mid points were evaluated.

### Volume Resistivity Measurement:

Volume resistivity was determined according to international standard IEC 62631 Mar. 1.

### Measurement of the Specific Reaction Enthalpy

The specific reaction enthalpy was determined by checking ca. 20 mg of the polyol composition/polyisocanate mixture in a DSC equipment. It was heated up from ambient temperature to about 260° C. with constant heating rate of 10 K/min. The heat flow signal was integrated between about 60° C. and 236° C. and the resulting heat released was divided by the exact mass of tested material. This results finally in specific reaction enthalpy value (J/g).

### VI—Test Results

TABLE 1

| | |
|---|---|
| Example 1 | Example 2 |
| (inventive) | (comparative) |

Polyol composition (A)

| | | |
|---|---|---|
| Baygal K 55 | 10 | 9.5 |
| Lupranol 2007/1 | 50 | |
| Lupranol 2095 | | |
| TEGOSTAB B 8863 Z | 4 | 3 |
| Cab-O-sil M5 | 2.4 | |
| Aerosil 200 | | 1.7 |
| HR 1862 | 4 | 2 |
| Nyflex 820 | 9.6 | 9.5 |
| Castor oil | 20 | |
| Sovermol 1111 | | 28.6 |
| Polybd R45 HTLO | | 45.7 |

Polyisocyanate (B)

| | | |
|---|---|---|
| Suprasec 2447 | 100 | 100 |
| Mass ratio (A):(B) | 100:20.25 | 100:25.00 |

Characterization of the polyol composition (A)

| | | |
|---|---|---|
| Content of unmodified renewable | 20 | 0 |
| natural components (%) | | |
| Halogen component content (%) | <0.1% | <0.1% |
| Storage stability of (A) | Stable during 1 | Stable during 1 |
| | month | month |
| Viscosity of component (A) at 25° C. | 1813 | 4000 |
| (mPas) | | |
| Relative cost for polyol | 100% | >150% |

Characterization of the reactive mixture of (A) and (B)

| | | |
|---|---|---|
| Viscosity of the (A) + (B) mixture at | 1530 | 2500 |
| 25° C. (mPas) | | |
| Molar ratio | 1.04 | 1.04 |
| NCO/reactive H of component (A) | | |
| Time to reach 5 Pa · s at 25° C. (min) | 61 | 32 |
| Gel time at 25° C. (min) | 430 | 160 |
| Gel time at 40° C. (min) | 215 | 112 |
| Gel time at 60° C. (min) | 105 | 55 |
| Tg (° C.) | −45 | −67 |
| Shore A | 35 | 69 |
| Tan delta (50 Hz, 23° C.) (%) | 10.3 | 4.3 |
| Dielectric constant (50 Hz, 23° C.) | 8.3 | 3.5 |
| (F/m) | | |
| Volume resistivity (50 Hz, 23° C.) | 6.4 · 10¹⁰ | 10¹⁴ |
| (Ω · cm) | | |
| Specific reaction enthalpy (J/g) | 44.4 | 67.9 |
| Temperature to generate foam in the | 23 | 23 |
| hollow core insulator (° C.) | | |

Example 3 (comparative): this example reproduces foam according to prior art WO2021/058500 which discloses way to fill hollow core insulators with thermally expandable hollow spheres. A poly (acrylonitrile-co-vinylidene chloride-co-methyl methacrylate) sold under the name Expancel® supplied by Nouryon was used. It was found that, apart from the fact that this composition includes halogen and its cost is much higher than that of the inventive composition of Example 1, it needs high temperature (ca. 160° C.) to activate the expansion of the hollow sphere in the hollow core insulator.

### VII—Discussion of the Results

The results summarized in Table 1 show that the polyol composition according to the invention (Example 1), compared to prior art compositions, is storage stable, has a high bio-content and comprised of available components in particular which are not restricted by the chemicals weapon convention. This composition has also the lowest cost.

When combined with the polyisocyanate component, the polyol composition according to the invention makes it possible to form a mixture that can be applied and cured at 23° C. Based on the results in Table 1, the curable composition according to the invention has:
a slower curing reaction, i.e., 61 min compared with 32 minutes in case of comparative Example 2, and higher gel times at different temperatures, thus a lower reactivity. This increase in reaction times is of a particular interest for the application as filler for large volumes of hollow core insulators,
a higher glass transition temperature,
a lower specific reaction enthalpy, i.e., 44 J/g compared with 67.9 J/g in case of comparative Example 2,
a higher softness, i.e., Shore A hardness=35 compared with Shore A hardness=69 in case of comparative Example 2,
a good temperature flexibility.

1. A polyol composition (A), comprising, based on the total weight of the composition,
a1) from 35% to 90% by weight of one or more polyether polyols having an average hydroxyl functionality of greater than 2,
a2) from 10% to 50% by weight of castor oil,
a3) from 5% to 30% by weight of one or more mineral oil,
a4) from 0.05% to 10% by weight of one or more foam stabilizing agent,
wherein at least 80% by weight of the total weight of polyols in the composition is provided by the polyether polyol a1) and the castor oil a2).

2. The polyol composition as claimed in claim 1 wherein the polyether polyol a1) is selected from linear or branched polyethylene oxide, polypropylene oxide, a hydroxy-terminated ethylene oxide/propylene oxide block copolymer and mixtures thereof.

3. The polyol composition as claimed in claim 1, wherein the polyether polyol is a mixture of a polyether polyol having a hydroxyl number inferior or equal to 200 mg KOH/g, and a polyether polyol having a hydroxyl number greater than 200 mg KOH/g.

4. The polyol composition as claimed in claim 3, wherein the polyether polyol a1) comprises from 5% to 20% by weight of one or more a polyether polyol having a hydroxyl number greater than 200 mg KOH/g and from 30% to 70% by weight of one or more polyether polyols having a hydroxyl number inferior or equal to 200 mg KOH/g, based on the total weight of the composition.

5. The polyol composition as claimed in anyone of claims 1, wherein the mineral oil a3) is a naphthenic mineral oil.

6. The polyol composition as claimed in claim 1, wherein the foam stabilizing agent a4) is selected from the group of polydimethylsiloxanes, organofunctional polydimethylsiloxanes, siloxane polyether copolymers, block-copolymers with silicone and organic blocks and mixtures thereof.

7. The polyol composition as claimed in claim 1, further comprising additives selected from epoxy components, rheological modifiers, surface-active substances, flame retardants, fillers, catalysts, drying agents, dyes, pigments, flameproofing agents, softening agents, thermal aging stabilizers, thixotropic agents, blowing agents and their mixture.

8. The polyol composition as claimed in claim 7, wherein the epoxy component is a polypropylenglycol diglycidyl ether.

9. The polyol composition as claimed in claim 7 wherein the rheological modifier is fumed silica.

10. The polyol composition as claimed in anyone of claims 1, which is free of polyolefin polyols.

11. A two-constituent composition comprising at least
a component (A) which is a polyol composition as claimed in anyone of claims 1,
a component (B) which is a polyisocyanate having an average NCO functionality greater than 2.

12. The composition as claimed in claim 11, wherein the component (B) comprises at least methyl diphenyl diisocyanate.

13. The composition as claimed in claim 11, wherein the molar ratio of the NCO groups of component (B) to the sum of the reactive hydrogen atoms in the component (A) ranges from 0.80:1 to 1.75:1.

14. A polyurethane foam obtained by reacting the polyol composition (A) and the component (B) of the composition as claimed in anyone of claims 11, in particular in presence of a blowing agent.

15. Use of a two-constituent composition and/or the polyurethane foam prepared therefrom for filling hollow core insulators, the composition comprising at least:
a component A) which is a polyol composition comprising, based on the total weight of the composition:
a1) from 35% to 90% by weight of one or more polyether polyols having an average hydroxyl functionality of greater than 2,
a2) from 10% to 50% by weight of castor oil, wherein at least 80% by weight of the total weight of polyols in the composition is provided by the polyether polyol a1) and the castor oil a2),
a component B) which is a polyisocyanate with an average NCO functionality of greater than 2.

16. A hollow core insulator filled with a polyurethane foam obtained by reacting the polyol composition (A) and the component (B) as claimed in claim 15.
